(19) United States
(12) Patent Application Publication
(10) Pub. No.: US 2011/0143872 A1
(43) Pub. Date: Jun. 16, 2011

(54) ELECTRONIC CONTROL V-BELT CONTINUOUSLY VARIABLE TRANSMISSION MECHANISM

(75) Inventors: Li-Yu CHEN, Hsinchu (TW); Yeu-Jou Lin, Hsinchu (TW)

(73) Assignees: INDUSTRIAL TECHNOLOGY RESEARCH INSTITUTE, Hsinchu (TW); Kwang Yang Motor Co., Ltd., Kaohsiung (TW)

(21) Appl. No.: 12/704,597

(22) Filed: Feb. 12, 2010

(30) Foreign Application Priority Data
Dec. 10, 2009 (TW) 098142226

(51) Int. Cl. F16H 59/00

(52) U.S. Cl. 474/23

(57) ABSTRACT

An electronic control V-belt continuously variable transmission mechanism is applied in a power transmission system having an engine and support shafts for a driving pulley and a driven pulley, characterized by driving the driving pulley with power supplied by a pulley driving system such that a movable portion of the driving pulley moves axially to the driving-pulley support shaft, thereby enabling a movable portion of a driven pulley connected to the driving pulley to move in response to the axial distance variation, thus changing the rotational speed of the driven pulley. The contact between a cam guide groove of a bearing base of the pulley driving system and a cam guide device is transmitted through rolling friction, and the transmission efficiency is increased by a complex lead angle effect formed between a lead angle of the cam guide groove and a lead screw.

### BACKGROUND OF THE INVENTION

1. Field of the Invention

The present invention relates generally to electronic control V-belt continuously variable transmission mechanisms, and more particularly, to an electronic control V-belt continuously variable transmission mechanism for use in a power transmission system having an engine and support shafts for a driving pulley and a driven pulley.

2. Description of Related Art

In a current electronic control V-belt continuously variable transmission mechanism disclosed by such as U.S. Pat. No. 7,237,638, a motor drives a lead screw through a gear system so as to bring a movable portion of a driving pulley to move axially, thereby replacing a conventional mechanism that axially moves a belt pulley through a centrifugal force. However, since the lead screw brings the movable portion of the driving pulley to axially move through a sliding contact means, and a guide portion for axial movement in the conventional electronic control belt continuously variable transmission mechanism is based on sliding friction, it leads to a friction loss of at least 10%. In addition, the lead screw that drives a movable portion of a driving pulley has only a transmission efficiency of about 60%, which results in a low transmission efficiency of the overall mechanism.

In the conventional electronic control belt continuously variable transmission mechanism, a belt is used for driving so as to increase the friction coefficient. However, the belt is easy to be contaminated by oil, which causes slipping of the belt during operation. In order to prevent the belt from being contaminated by oil, transmission components driven by the motor such as lead screws, gears and bearings need to be lubricated by grease and sealed through a local-segment sealing method. However, the local-segment sealing method is not reliable and requires frequent maintenance, and the grease lubricating effect is not so good as that of wet lubrication.

Therefore, it is imperative to provide an electronic control V-belt continuously variable transmission mechanism so as to achieve preferred lubrication and sealing effects and improved transmission efficiency.

### SUMMARY OF THE INVENTION

In view of the above drawbacks, an object of the present invention is to provide an electronic control V-belt continuously variable transmission mechanism so as to improve the overall transmission efficiency thereof.

Another object of the present invention is to provide an electronic control V-belt continuously variable transmission mechanism so as to achieve preferred lubricating and sealing effects.

1. In order to achieve the above and other objectives, the present invention provides a an electronic control V-belt continuously variable transmission mechanism applicable to a power transmission system having a power source, a support shaft for a driving pulley (i.e., a driving-pulley support shaft) and a support shaft for a driven pulley (i.e., a driven-pulley support shaft). The mechanism comprises: a V-belt; a driving pulley having a fixed portion fixed to the driving-pulley support shaft and a movable portion movable in an axial direction with respect to the driving-pulley support shaft, the driving pulley being driven by the power source; a driven pulley connected to the driving pulley and having a fixed portion fixed to the driven-pulley support shaft and a movable portion arranged for axial movement and rotation with respect to the driven-pulley support shaft, the driven pulley being driven by the driving pulley through the V-belt; a pulley driving system connected to the driving pulley for providing power to drive the movable portion of the driving pulley to move in the axial direction, thereby varying the distance between the fixed portion and the movable portion of the driving pulley, the movable portion of the driven pulley being axially moved and rotated in response to the distance variation of the movable portion of the driving pulley so as to vary a speed of rotation of the driven pulley; and a transmission box base for accommodating the driving pulley, the driven pulley and the pulley driving system, wherein the pulley driving system comprises: a bearing base disposed on the movable portion of the driving pulley and connected by a roller to the driving-pulley support shaft, the bearing base having at least a cam guide groove; a gear box cover assembled with the front end of the transmission box base; and at least a cam guide device disposed between the gear box cover and the cam guide groove of the bearing base to guide the bearing base to move axially.

In a preferred embodiment, the mechanism further comprises a transmission box cover assembled with the transmission box base so as to cover the driving pulley and the driven pulley. The pulley driving system further comprises: a motor for providing power; a gear system disposed between the motor and the driving pulley for transmitting power of the motor to the movable portion of the driving pulley, wherein the gear system has a lead screw connected to the bearing base; and a seal unit disposed on the gear box cover and the bearing base for preventing leakage of lubricating oil from the gear system using wet lubrication. The gearbox cover is assembled with the front end of the transmission box base so as to cover the gear system, thereby forming a sealed wet lubrication system. The space formed between the gearbox cover and the front end of the transmission box base communicates with a crankcase of the power source such that the gear system can be lubricated by lubricating oil of the crankcase. The power source is an engine. The cam guide groove has a lead angle such that when the bearing base moves axially, it can rotate about the axis of the driving-pulley support shaft, thereby adjusting the axial travel distance of the movable portion of the driving pulley. The fixed portions of the driving pulley and the driven pulley are fixed pulley discs and the movable portions of the driving pulley and the driven pulley are movable pulley discs. The driving-pulley support shaft is a crankshaft and the driven-pulley support shaft is a rear output shaft. The contact between the cam guide device and the cam guide groove is transmitted through rolling friction.

Therefore, the present invention uses a rolling friction transmission method on the cam guide groove to reduce friction loss when the bearing base on the movable portion of the driving pulley is guided to make axial movement, thereby improving the transmission efficiency. Further, the lead angle of the cam guide groove and the lead screw form a complex lead angle effect, thus increasing the lead angle of the lead screw and the transmission efficiency. Furthermore, a sealed gear box is formed between the gear box cover and the transmission box base, and a seal unit is disposed on the bearing base and the gear box cover as well as the movable portion of the driving pulley for preventing leakage of lubricating oil. Meanwhile, since the transmission box base has an inlet and an outlet communicating with the crankcase, splashing oil fog of the crankcase can lubricate the gear system of the gearbox, thereby improving the lubricating effect and the sealing effect.

### BRIEF DESCRIPTION OF DRAWINGS

FIG. 1 is a partially sectional view of a driving end of an electronic control V-belt continuously variable transmission mechanism of the present invention;

FIG. 2 is a partially sectional view of a driven end of the electronic control V-belt continuously variable transmission mechanism of the present invention;

FIG. 3 is a top partially sectional view of a gearbox cover of the electronic control V-belt continuously variable transmission mechanism of the present invention;

FIG. 4 is a partially sectional view of a part of the transmission mechanism operated by the motor of the present invention;

FIG. 5 is a sectional view of a part of the transmission mechanism related to the transmission box base of the present invention; and

FIG. 6 is a diagram showing the rotation distance of a cam guide groove and a lead screw of the electronic control V-belt continuously variable transmission mechanism of the present invention.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

The electronic control V-belt continuously variable transmission mechanism of the present invention is applicable to a power transmission system having an engine, a support shaft for a driving pulley and a support shaft for a driven pulley. The electronic control V-belt continuously variable transmission mechanism of the present invention comprises: a V-belt, a driving pulley, a driven pulley, a pulley driving system, a transmission box base and a transmission box cover.

Therein, the driving pulley has a fixed portion fixed to the driving-pulley support shaft and a movable portion movable along an axial direction with respect to the support shaft, the driving pulley being driven by the engine; the driven pulley is connected to the driving pulley and has a fixed portion fixed to the driven-pulley support shaft and a movable portion arranged for axial movement and rotation with respect to the support shaft, the driven pulley being driven by the driving pulley through the V-belt; the pulley driving system is connected to the driving pulley for providing power to drive the movable portion of the driving pulley to move in the axial direction, thereby varying the distance between the fixed portion and the movable portion of the driving pulley, the movable portion of the driven pulley being further axially moved and rotated in response to the distance variation of the movable portion of the driving pulley so as to vary a speed of rotation of the driven pulley; the transmission box base is used for accommodating the driving pulley, the driven pulley and the pulley driving system; and the transmission box cover is assembled with the transmission box base so as to cover the driving pulley and the driven pulley.

The pulley driving system further comprises: a motor for providing power; a bearing base disposed on the movable portion of the driving pulley and roller-connected (i.e., through a roller connection) to the driving-pulley support shaft, the bearing base having at least a cam guide groove; a gear system disposed between the motor and the driving pulley for transmitting power of the motor to the movable portion of the driving pulley, wherein the gear system has a lead screw connected to the bearing base on the movable portion of the driving pulley; a gear box cover assembled with the front end of the transmission box base so as to cover the gear system, thereby forming a sealed wet lubrication system; at least a cam guide device disposed between the gear box cover and the cam guide groove of the bearing base on the movable portion of the driving pulley so as to guide the bearing base to move axially; and a seal unit disposed on the gear box cover and the bearing base on the movable portion of the driving pulley for preventing leakage of lubricating oil from the gear system using wet lubrication, wherein the contact between the cam guide device and the cam guide groove is transmitted through rolling friction; the space formed between the gear box cover and the front end of the transmission box base communicates with a crankcase of the engine such that the gear system can be lubricated by lubricating oil of the crankcase; the cam guide groove of the bearing base on the movable portion of the driving pulley has a lead angle such that the bearing base on the movable portion of the driving pulley can rotate about the axis of the driving-pulley support shaft when the bearing base moves axially, thereby adjusting the axial movement of the movable portion of the driving pulley; the fixed portions of the driving pulley and the driven pulley are fixed pulley discs and the movable portions of the driving pulley and the driven pulley are movable pulley discs; the driving-pulley support shaft is a crankshaft and the driven-pulley support shaft is a rear output shaft.

The electronic control V-belt continuously variable transmission mechanism of the present invention is described in detail below with reference to the drawings.

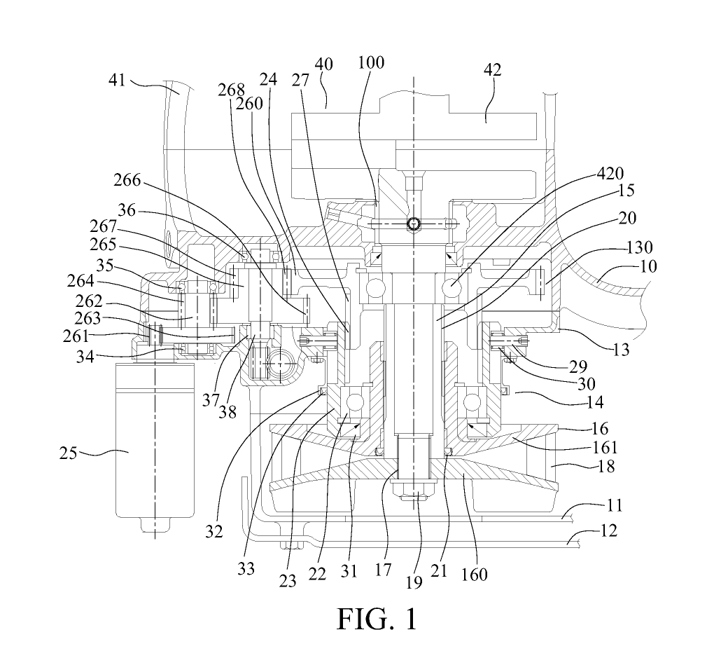

FIG. 1 is a partially sectional view of a driving end of the electronic control V-belt continuously variable transmission mechanism. Referring to FIG. 1, the electronic control V-belt continuously variable transmission mechanism is disposed inside a transmission box base 10, a transmission base cover 11, an outer cover 12 and a gearbox cover 13. The transmission box base 10 is a part of a crankcase 41 of an engine 40. The gearbox cover 13 is disposed to the front end of the transmission box base 10, covering a gear system 130 (the space formed by the gear box cover 13 and the front end of the transmission box base 10 communicates with the crankcase 41 of the engine 40). Referring to FIG. 1, a crank shaft 42 disposed on the engine 40 is supported by a bearing 100 provided on the transmission box base 10 and extends into a transmission box 14 for transmitting power of the engine 40. A spline bushing 15 is disposed on the crankshaft 42. A fixed pulley disc 160 of a driving pulley 16 (driving end) is disposed to a spline 17 of the crank shaft 42, and a movable pulley disc 161 of the driving pulley 16 is disposed to the spline bushing 15 and movable along an axial direction with respect to the crank shaft 42. A V-belt 18 extends around and between the driving pulley 16 and a driven pulley (to be described later in detail). The fixed pulley disc 160 of the driving pulley 16 is fixed by a nut 19 to the outer peripheries of a bearing 420 and the spline bushing 15 of the crank shaft 42, thereby transmitting power from the engine 40 to the transmission box 14 through the crank shaft 42. The spline 17 of the crank shaft 42 is located inside and engaged with the spline bushing 15, and a spline 20 is formed on the outside of the spline bushing 15 and connected to the movable pulley disc 161 of the driving pulley 16 such that the movable pulley disc 161 of the driving pulley 16 can be driven by the crank shaft 42 to move axially on the spline bushing 15. The movable pulley disc 161 of the driving pulley 16 has a seal unit 21 disposed thereon for preventing leakage of lubricating oil.

The movable pulley disc 161 of the driving pulley 16 has a bearing 22 disposed thereon, and is movable axially when driven by a bearing base 23. An inner lead screw 24 is provided to an inner side of the bearing base 23, and engages with an outer lead screw 27 provided on a gear 260 of a gear system driven by a motor 25. Further, the bearing base 23 has a cam guide groove 28 provided thereon. The cam guide groove 28 is coupled with a rolling bearing 30 of a cam guide device 29 (cam tip) locked on the gearbox cover 13. As such, when the gear 260 is driven to rotate by the motor 25, the inner lead screw 24 is brought to move through the outer lead screw 27, thereby driving the bearing base 23 to move axially and rotate. Since the bearing 22 is disposed between the movable pulley disc 161 and the bearing base 23, the movable pulley disc 161 can rotate relative to the bearing base 23. The bearing base 23 further has a seal unit 31 disposed thereon for preventing leakage of lubricating oil of the bearing 22. An outer cover 32 and a seal unit 33 provided on the gear box cover 13 can prevent leakage of lubricating oil of the cam guide groove 28.

Further, the gear 260 of the gear system is disposed on the bearing 420 of the crank shaft 42, and driven to rotate by the motor 25 disposed on the gear box cover 13. Driven by the motor 25, a gear 261 brings a gear 263 of a shaft gear 262 supported by a bearing 34 and a bearing 35 to move, and a gear 264 of the shaft gear 262 drives a gear 266 of a cluster gear 265 supported by a bearing 36 and a bearing 37 to move, wherein the cluster gear 265 has one end disposed with a worm shaft 38, and a gear 267 of the cluster gear 265 further drives a gear 268 on the gear 260 to move. Through the outer lead screw 27 of the gear 260, the inner lead screw 24 further drives the bearing base 23 to move axially, thereby changing the axial distance between the movable pulley disc 161 and the fixed pulley disc 160 of the driving pulley 16 and thereby correspondingly changing the groove width of the V-belt of the driving pulley 16 so as to change the radius of contact between the V-belt 18 and the driving pulley 16. If the groove width increases, the radius of contact between the V-belt 18 and the driving pulley 16 decreases; otherwise, if the groove width decreases, the radius of contact between the V-belt 18 and the driving pulley 16 increases.

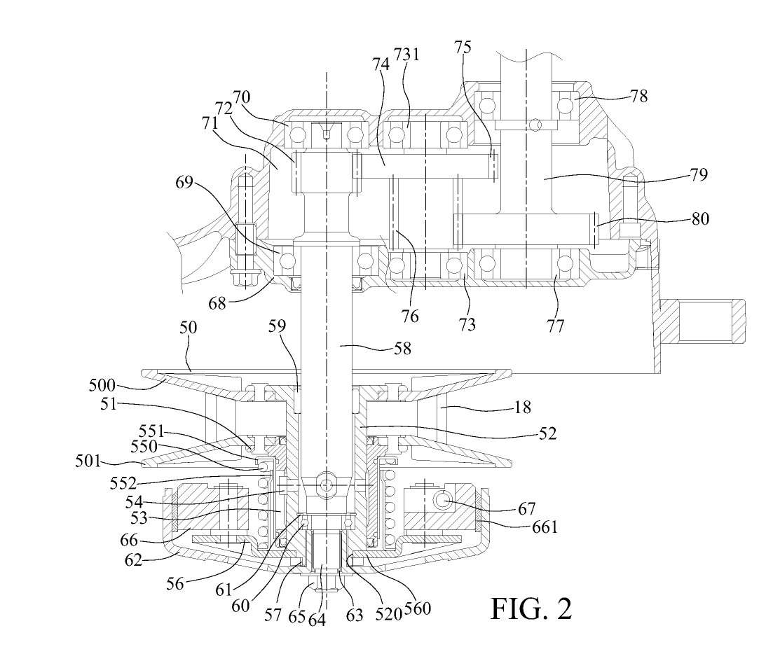

Referring to FIG. 2, a driven pulley 50 (driven end) is comprised of a fixed pulley disc 500 and a movable pulley disc 501. A hub 51 of the movable pulley disc 501 is disposed on a hub 52 of the fixed pulley disc 500. A cam guide groove 53 is disposed on the hub 51 of the movable pulley disc 501, and engages with a cam guide device 54 (cam tip) disposed on the hub 52 of the fixed pulley disc 500 so as to restrict movement of the movable pulley disc 501. A compression spring 550, and spring housings 551 and 552 are disposed on the hub 51 of the movable pulley disc 501, wherein the spring housing 552 is pressed by a centrifugal clutch driving plate 56 and fixed by a nut 57 to the hub 52 of the fixed pulley disc 500 so as to provide a pre-load spring force. The movable pulley disc 501 is pushed towards the fixed pulley disc 500 by an axial force of the compression spring 550 so as to generate tension on the V-belt 18 disposed to the driven pulley 50 and driving pulley 16. If the radius of contact between the driven pulley 50 and the V-belt 18 increases, the tension of the V-belt 18 decreases; otherwise, if the radius of contact between the driven pulley 50 and the V-belt 18 decreases, the tension of the V-belt 18 increases.

In addition, the driven pulley 50 is disposed on bearings 59, 60 of a rear output shaft 58, wherein the bearing 60 is fixed to the hub 52 of the fixed pulley disc 500 through a snap ring 61. A centrifugal clutch driven plate 62 is disposed around an external spline 64 of the rear output shaft 58 through an internal spline 63 thereof, and fixed to the rear output shaft 58 along with the bearing 60 by a nut 65. An inner flange 560 of the centrifugal clutch driving plate 56 is disposed around a flat milled portion 520 of the hub 52 of the fixed pulley disc 500 to rotate synchronously with the fixed pulley disc 500. As such, under a centrifugal force generated by rotation, power of the driven pulley 50 is transmitted to the centrifugal clutch driven plate 62 through the centrifugal clutch driving plate 56, a centrifugal block 66, a centrifugal block spring 67 and a centrifugal brake sheet 661 and further transmitted to the rear output shaft 58. The rear output shaft 58 is supported by a bearing 69 disposed on a rear shaft deceleration box cover 68 and a bearing 70 disposed on the transmission box base 10 so as to transmit power generated by the engine 40 to a rear shaft deceleration box 71 sealed by the transmission box base 10 and the rear shaft deceleration box cover 68. Through a gear 72 of the rear output shaft 58, power is transmitted to a gear 75 of a clutch gear 74 supported by bearings 73 and 731, and further transmitted through a gear 76 to a gear 80 of a rear wheel shaft 79 supported by bearing 77 and 78, thereby transmitting power of the engine 40 to such as a rear wheel of a vehicle.

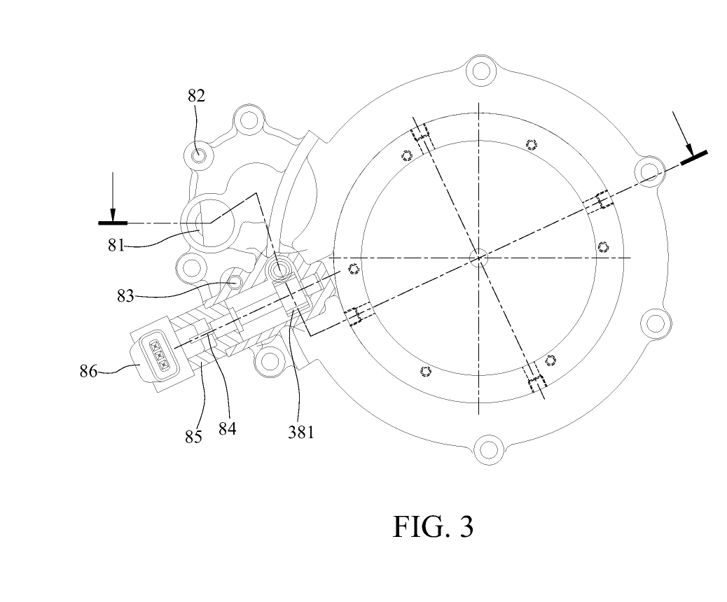

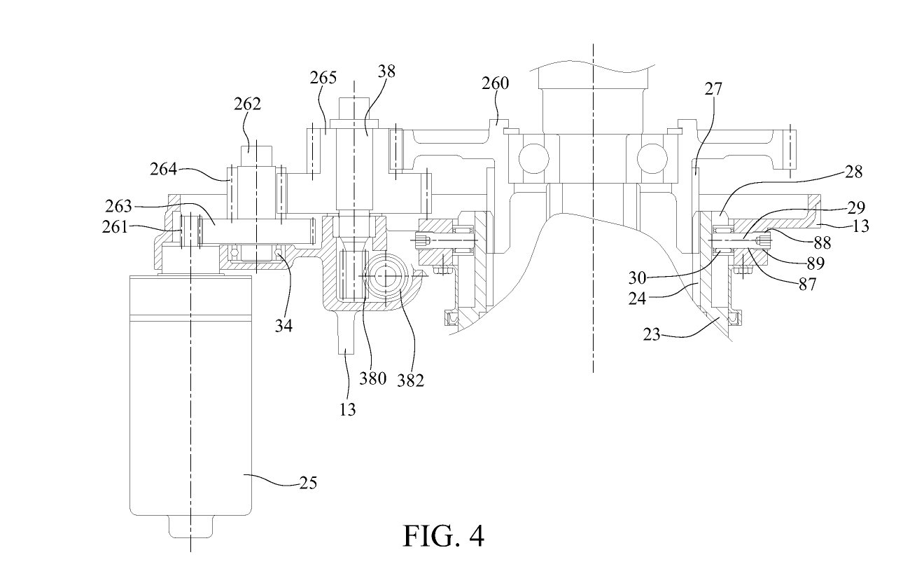

FIG. 3 is a top partially sectional view of the gearbox cover and FIG. 4 is a partially sectional view of a part of the transmission mechanism operated by the motor. Referring to FIGS. 3 and 4, the motor 25 is disposed to a through hole 81 of the gearbox cover 13 and locked to screw holes 82 and 83. Rotation of the motor 25 is transmitted to the bearing base 23 through the shaft gear 262, the clutch gear 265, the gear 260, the outer lead screw 27 and the inner lead screw 24, and the cam guide groove 28 of the bearing base 23 is guided by the cam guide device 29 (cam tip) on the gear box cover 13 to axially move and rotate. Rotation displacement of the clutch gear 265 is transmitted through a worm 380 of the worm shaft 38 to a worm 382 of a worm gear 381, and the flange 84 of worm 382 is coupled with an angular displacement sensing element 86 disposed on a sensing element base 85 such that the angular displacement sensing element 86 provides control feedback information to the motor 25. Referring to FIG. 4, the cam guide device 29 is disposed to a positioning hole 87 of the gear box cover 13 and locked to a screw hole 89 of the gear box cover 13 such that the rolling bearing 30 of the cam guide device 29 is in contact with the cam guide groove 28 of the bearing base 23.

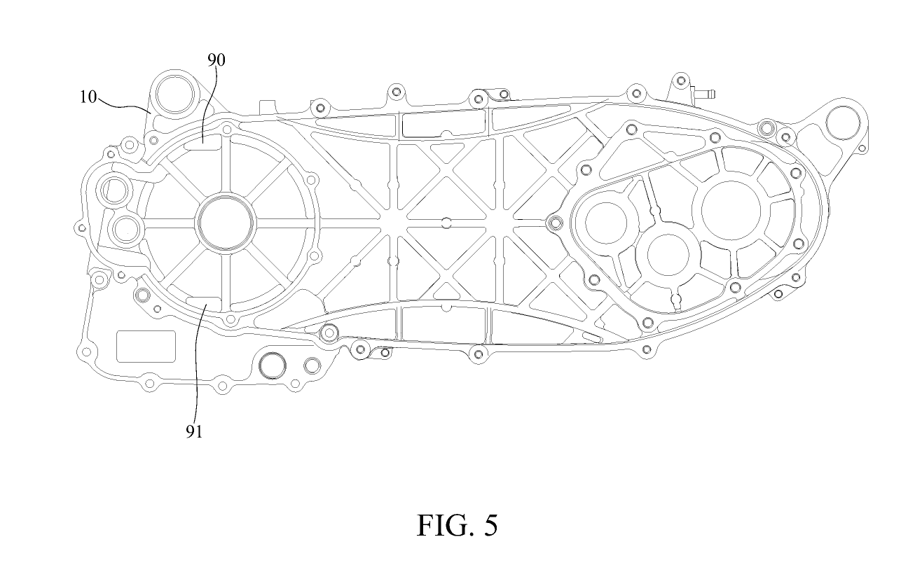

Referring to FIG. 5, the transmission box base 10 has through holes 90 and 91 communicating with the crankcase 41 (the transmission box base 10 is a part of the crankcase 41 of the engine 40) such that lubricating oil of the crankcase 41 can be provided to the gear system 130 for use.

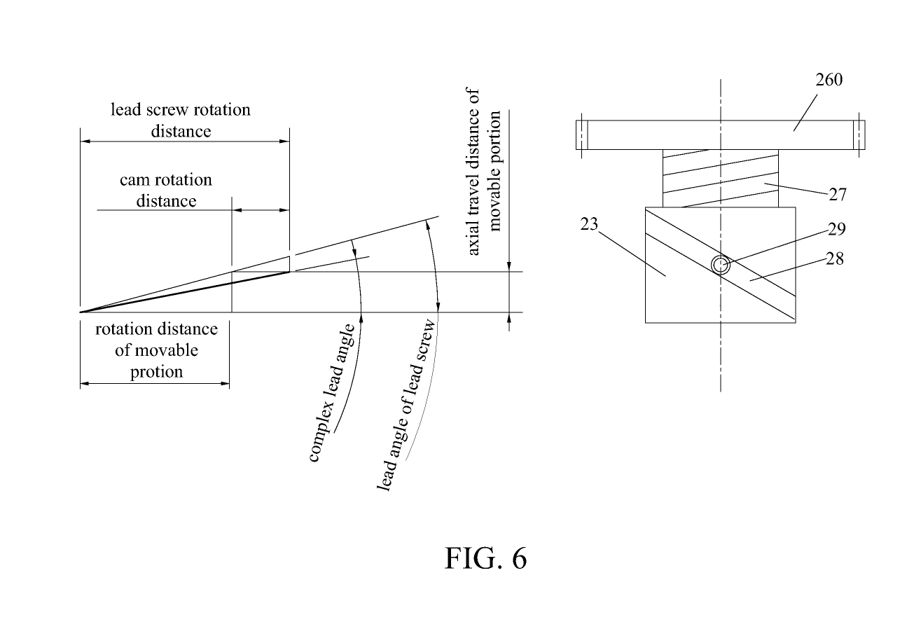

Further referring to FIG. 6, the cam guide groove 28 in the right part of the figure has a lead angle shown in the left part. When the lead angle direction of the cam guide groove 28 is opposite to that of the lead screw (outer lead screw 27), the rotation direction of the bearing base 23 is the same as that of the lead screw (outer lead screw 27), thereby improving the transmission efficiency through a lead screw with a big lead angle and meanwhile achieving a self-locking effect through a smaller complex lead angle (as shown in the left part), wherein the lead angle can be controlled through the axial travel distance of the movable pulley disc 161 and the rotation distance of the movable portion.

Therefore, the present invention uses a rolling friction transmission method on the cam guide groove to reduce friction loss when the bearing base on the movable pulley disc of the driving pulley is guided to make axial movement, thereby improving the transmission efficiency. Further, the lead angle of the cam guide groove and the lead screw form a complex lead angle effect, thus increasing the lead angle of the lead screw and the transmission efficiency while maintaining a self-locking function of the complex lead screw mechanism. Furthermore, a sealed gear box is formed between the gear box cover and the transmission box base, and a seal unit (oil seal) is disposed on the bearing base and the gear box cover as well as the driving pulley disc of the driving pulley for preventing leakage of lubricating oil. Meanwhile, since the transmission box base has an inlet and an outlet communicating with the crankcase, splashing oil fog of the crankcase can lubricate the gear system of the gearbox, thereby improving the lubricating effect and the sealing effect.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. An electronic control V-belt continuously variable transmission mechanism, comprising:
a V-belt;
a driving pulley having a fixed portion fixed to a driving-pulley support shaft and a movable portion movable in an axial direction with respect to the driving-pulley support shaft, the driving pulley being driven by a power source;
a driven pulley connected to the driving pulley and having a fixed portion fixed to a driven-pulley support shaft and a movable portion arranged for axial movement and rotation with respect to the driven-pulley support shaft, the driven pulley being driven by the driving pulley through the V-belt;
a pulley driving system connected to the driving pulley for providing power to drive the movable portion of the driving pulley to move in the axial direction with respect to the driving-pulley support shaft, thereby varying the distance between the fixed portion and the movable portion of the driving pulley, the movable portion of the driven pulley being axially moved and rotated with respect to the driven-pulley support shaft in response to a distance variation of the movable portion of the driving pulley in the axial direction with respect to the driving-pulley support shaft, so as to vary a speed of rotation of the driven pulley; and
a transmission box base for accommodating the driving pulley, the driven pulley and the pulley driving system;
wherein the pulley driving system comprises:
a bearing base disposed on the movable portion of the driving pulley and roller-connected to the driving-pulley support shaft, the bearing base having at least a cam guide groove;
a gear box cover assembled with the front end of the transmission box base; and
at least a cam guide device disposed between the gearbox cover and the cam guide groove of the bearing base to guide the bearing base to move axially.

2. The mechanism of claim 1, further comprising a transmission box cover assembled with the transmission box base so as to cover the driving pulley and the driven pulley.

3. The mechanism of claim 1, wherein the pulley driving system further comprises:
a motor for providing power;
a gear system disposed between the motor and the driving pulley for transmitting power of the motor to the movable portion of the driving pulley, wherein the gear system has a lead screw connected to the bearing base; and
a seal unit disposed on the gearbox cover and the bearing base for preventing leakage of lubricating oil from the gear system using wet lubrication.

4. The mechanism of claim 3, wherein the gear box cover is assembled with the front end of the transmission box base so as to cover the gear system, thereby forming a sealed wet lubrication system.

5. The mechanism of claim 4, wherein the space formed between the gear box cover and the front end of the transmission box base communicates with a crankcase of the power source such that the gear system can be lubricated by lubricating oil of the crankcase.

6. The mechanism of claim 5, wherein the power source is an engine.

7. The mechanism of claim 1, wherein the power source is an engine.

8. The mechanism of claim 1, wherein the cam guide groove has a lead angle such that the bearing base on the movable portion of the driving pulley can rotate about the axis of the driving-pulley support shaft when the bearing base moves axially, thereby adjusting the axial travel distance of the movable portion of the driving pulley.

9. The mechanism of claim 1, wherein the fixed portions of the driving pulley and the driven pulley are fixed pulley discs and the movable portions of the driving pulley and the driven pulley are movable pulley discs.

10. The mechanism of claim 9, wherein the fixed pulley disc of the driving pulley is disposed to a spline of a crankshaft.

11. The mechanism of claim 10, wherein the movable pulley disc of the driving pulley is disposed on a spline bushing of the support shafts and movable axially.

12. The mechanism of claim 11, wherein the fixed pulley disc is locked by a nut to the outer peripheries of the bearings and the spline bushings of the support shafts, respectively.

13. The mechanism of claim 11, wherein the movable pulley discs are connected to the spline engaged with the spline bushing.

14. The mechanism of claim 1, wherein the driving-pulley support shaft is a crankshaft and the driven-pulley support shaft is a rear output shaft.

15. The mechanism of claim 1, wherein the contact between the cam guide device and the cam guide groove is transmitted through rolling friction.

16. The mechanism of claim 1, wherein the V-belt extends around and between the driving pulley and the driven pulley.

17. The mechanism of claim 1, wherein the driving pulley is directly driven to rotate by an engine.

18. The mechanism of claim 1, wherein the bearing base has an inner lead screw disposed to an inner side thereof and engaging with an outer lead screw on a gear of the gear system driven by the motor.

19. The mechanism of claim 18, wherein the cam guide groove of the bearing base is coupled with a rolling bearing of the cam guide device such that the bearing base can be driven to move axially by the motor through the gear system.

20. The mechanism of claim 19, wherein power from the motor is transmitted through a gear on the output shaft of the motor and two gears on a shaft gear to bring a cluster gear to move, and a gear of the cluster gear drives the outer lead screw which further drives the inner lead screw of the bearing base, thereby driving the bearing base to move axially.

21. The mechanism of claim 20, wherein the cluster gear has a worm disposed to one side thereof; the worm drives a worm of a worm gear; and the flange of the worm of the worm gear is coupled to an angular displacement sensing element disposed on a sensing element base for providing rotation displacement of the cluster gear as control feedback information to the motor.

22. The mechanism of claim 3, wherein the transmission box base communicates with a crankcase such that lubricating oil of the crankcase can be provided for use in the gear system.
